(19) United States
(12) Patent Application Publication
(10) Pub. No.: US 2019/0057456 A1
(43) Pub. Date: Feb. 21, 2019

(54) SYSTEM AND METHODS THEREOF FOR ASSOCIATING ELECTRONIC DOCUMENTS TO EVIDENCE

(71) Applicant: Vatbox, Ltd., Herzeliya (IL)

(72) Inventors: Isaac SAFT, Kfar Neter (IL); Noam GUZMAN, Ramat Hasharon (IL)

(73) Assignee: Vatbox, Ltd., Herzeliya (IL)

(21) Appl. No.: 16/110,858

(22) Filed: Aug. 23, 2018

Related U.S. Application Data
(60) Provisional application No. 62/547,119, filed on Aug. 18, 2017.

(51) Int. Cl. G06Q 40/00; G06F 17/30; G06N 99/00

(52) U.S. Cl. CPC G06Q 40/123; G06N 99/005; G06F 17/30011

(57) ABSTRACT

A system and method for associating of a primary evidence with at least one secondary evidence, comprising: determining if a primary evidence contains a required information; extracting at least one distinguishing identifier from the primary evidence upon determination that the primary evidence lacks the required information; searching a data source for at least one secondary evidence that has an association with the primary evidence based on the at least one distinguishing identifier; and, determining whether the at least one secondary evidence qualifies as an eligible secondary evidence and associating the at least one secondary evidence with the primary evidence when it is determined that the at least one secondary evidence is an eligible secondary evidence.

### CROSS-REFERENCE TO RELATED APPLICATIONS

This application claims the benefit of U.S. Provisional Application No. 62/547,119 filed on Aug. 18, 2017, the contents of which are hereby incorporated by reference.

### TECHNICAL FIELD

The present disclosure relates generally to analyzing electronic documents, and more particularly to associating evidences for accurately processing such electronic documents.

### BACKGROUND

In countries where value added tax (VAT) is assessed and collected, and in some cases various other taxes as well, there exists a process for VAT reclaim. Such reclaim is typical for legal entities, for example companies, that both charge VAT and pay VAT. When an entity charges VAT, an amount is recorded in a VAT tax receipt and that amount is due to the tax collector. These entities also pay VAT when they make purchases of many kinds. Depending on particular tax laws such entities may deduct the amount of VAT paid from the amount of VAT collected. This is typically done on a monthly or bi-monthly basis.

It is straightforward for an entity to properly track the VAT it has collected by tallying the VAT that appears on each tax receipt issued by the entity. However, it can become more complex when attempting to deduct the VAT paid by the entity, as these payments may come from many different sources, have different formats and forms, and in many cases, for example, in the case of hotel receipts, may include only the name of the guest in the room and not the name of the entity making the payment and now wishing to reclaim the VAT.

This is often tedious and error prone work when done in small numbers and a daunting to impossible task when a large number of tax receipts must be processed. In some cases, it is permissible to provide secondary evidence when the primary evidence, i.e., the tax receipt, does not include the necessary information to associate it with the reclaiming entity. Such secondary evidence may be of various types, for example a trip report, an expense report, an e-mail, and the like, which may accompany the primary evidence.

Often a demand for such evidence may be required several years after the event has taken place and the reclaim made, e.g., when the entity is being audited by auditors, tax authorities, and the like. Furthermore, for large businesses, the amount of data utilized daily by businesses can be overwhelming. Accordingly, manual review and validation of such data is impractical at best. Further, disparities between recordkeeping documents can cause significant problems for businesses such as, for example, failure to properly report earnings to tax authorities.

Some solutions exist for automatically recognizing information in scanned documents (e.g., invoices and receipts) or other unstructured electronic documents (e.g., unstructured text files). Such solutions often face challenges in accurately identifying and recognizing characters and other features of electronic documents.

Moreover, degradation in content of the input of unstructured electronic documents typically result in high error rates. As a result, existing image recognition techniques, which are not completely accurate under ideal circumstances (i.e., using very clear images), often have a dramatic decrease in accuracy when input images are less clear. Moreover, missing or otherwise incomplete data can result in errors during subsequent use of the data. Many existing solutions cannot identify missing data unless, e.g., a field in a structured dataset is left incomplete.

In addition, existing image recognition solutions may be unable to accurately identify some or all special characters (e.g., “!”, “@”, “#”, “$”, “©”, “%,” “&,” etc.). As an example, some existing image recognition solutions may inaccurately identify a ‘!’ included in a scanned receipt as the number “1.” As another example, some existing image recognition solutions cannot identify special characters such as the dollar sign, the yen symbol, etc.

Further, such solutions may face challenges in preparing recognized information for subsequent use. Specifically, many such solutions either produce output in an unstructured format, or can only produce structured output if the input electronic documents are specifically formatted for recognition by an image recognition system. The resulting unstructured output typically cannot be processed efficiently. In particular, such unstructured output may contain duplicates, and may include data that requires subsequent processing prior to use. This would cause to failure in providing the secondary evidence as required.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for associating of a primary evidence with at least one secondary evidence, comprising: determining if a primary evidence contains a required information; extracting at least one distinguishing identifier from the primary evidence upon determination that the primary evidence lacks the required information; searching a data source for at least one secondary evidence that has an association with the primary evidence based on the at least one distinguishing identifier; and, determining whether the at least one secondary evidence qualifies as an eligible secondary evidence and associating the at least one secondary evidence with the primary evidence when it is determined that the at least one secondary evidence is an eligible secondary evidence.

Certain embodiments disclosed herein also include a non-transitory computer readable medium having stored thereon instructions for causing a processing circuitry to perform a process, the process comprising: a determining if a primary evidence contains a required information; extracting at least one distinguishing identifier from the primary evidence upon determination that the primary evidence lacks the required information; searching a data source for at least one secondary evidence that has an association with the primary evidence based on the at least one distinguishing identifier; and, determining whether the at least one secondary evidence qualifies as an eligible secondary evidence and associating the at least one secondary evidence with the primary evidence when it is determined that the at least one secondary evidence is an eligible secondary evidence.

Certain embodiments disclosed herein also include a report generator for associating of a primary evidence with at least one secondary evidence, comprising: a processing circuitry; and a memory, the memory containing instructions that, when executed by the processing circuitry, configure the system to: determine if a primary evidence contains a required information; extract at least one distinguishing identifier from the primary evidence upon determination that the primary evidence lacks the required information; search a data source for at least one secondary evidence that has an association with the primary evidence based on the at least one distinguishing identifier; and, determine whether the at least one secondary evidence qualifies as an eligible secondary evidence and associate the at least one secondary evidence with the primary evidence when it is determined that the at least one secondary evidence is an eligible secondary evidence.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart for associating secondary evidence to primary evidence for the purpose of electronic documents processing and auditing according to an embodiment.

FIG. 3 is a flowchart for the training of a learning machine for validating a model of association of secondary evidence to primary evidence according to an embodiment.

FIG. 4 is a schematic diagram of a report generator according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

By way of example to the disclosed embodiments, a method for providing primary evidence for analyzing electronic documents is provided. In an embodiment, the analysis of such documents is for the purpose of tax reclaim, such as value added tax (VAT) reclaim and post auditing of such reclaims. In such an example embodiment, the primary evidence is typically a tax receipt having various details thereon. The method may utilize one or more sources containing secondary evidence. A secondary evidence may be necessary when a primary evidence is missing essential information relating to the connection between the primary evidence and the entity requesting, for example, the tax reclaim. In an embodiment, the primary evidence is identified an being associated with the secondary evidence.

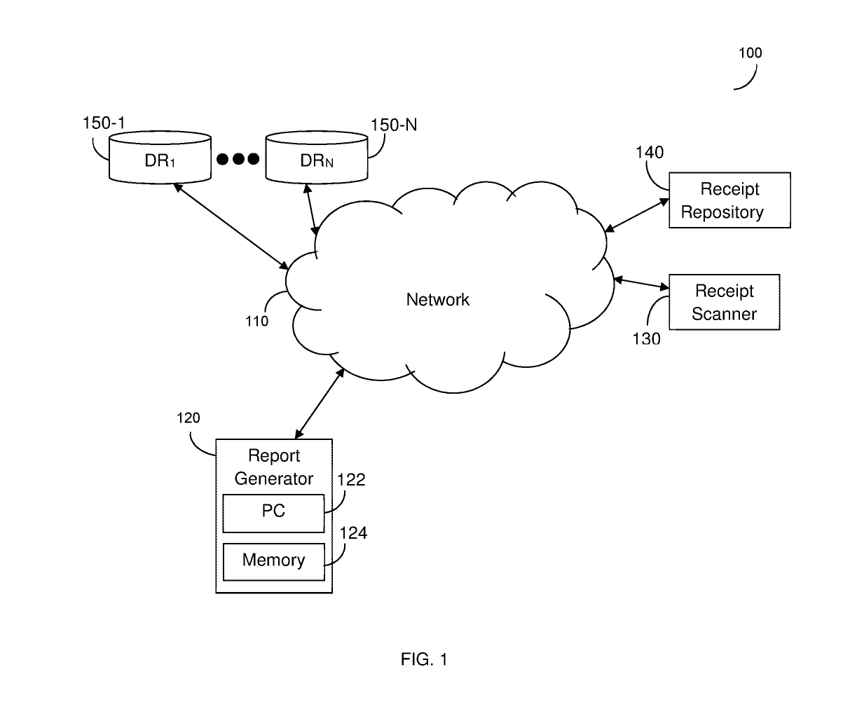

FIG. 1 shows an example network diagram 100 utilized to describe the various disclosed embodiments.

In the example network diagram 100, a report generator 120, a receipt scanner 130, a receipt repository 140, a plurality of web sources 150-1 through 150-N (where N is an integer equal to or greater than 1, hereinafter referred to individually as a web source 150 and collectively as web sources 150, merely for simplicity purposes) are communicatively connected via a network 110. The network 110 may be, but is not limited to, a wireless, cellular or wired network, a local area network (LAN), a wide area network (WAN), a metro area network (MAN), the Internet, and any combination thereof.

The report generator 120 is configured to execute the process for associating electronic documents with evidence as discussed in detail herein. As discussed below, such an association can be performed using a classifier (not shown) trained to associate a primary evidence with a secondary primary evidence. The classifier can be trained using any application of a machine learning technique.

The classifier can, over time, reach a level of competency that will allow it to ever more accurately ensure that secondary evidence collected in conjunction with a primary evidence provides strong proof for the eligibility of the primary evidence for the purposes of tax reclaim, and in particular VAT reclaim. The classifier may be trained using previous associations between primary evidence and secondary evidence from internal or external sources. An embodiment of the report generator 120 includes a processor 122 and a memory 124 to execute the method described herein. An example block diagram of the report generator 120 is provided below.

The scanner 130 is also communicatively connected to the network 110 and configured to scan documents, such as but not limited to, paper tax receipts as a primary evidence as well as other documents that may be used as secondary evidence. To this end, the scanner 130 may be further configured to utilize optical character recognition (OCR) or other image processing techniques to output an electronic document and to determine the data contained in the electronic document. In an embodiment, the scanner 130 may be embedded in the report generator 120.

The scanner 130 is connected to a repository 140, for example a database that contains the primary evidences, e.g., tax receipts, such as value added tax receipts, which may be scanned or otherwise provided as electronic primary evidence, as in many cases such evidences are sent electronically without actually printing the document.

The data resources 150 may be, but are not limited to, data repositories or databases holding a variety of secondary evidences in the forms of e-mails, text files, presentations, payment by the entity from an entity account, and other such electronic forms whether scanned or original. According to an embodiment, and as further described herein, the report generator 120 is adapted to associate a primary evidence from the repository 140 with at least one secondary evidence, if and when such exists, stored in a data resource 150. This is performed when it is established that on its own the primary evidence may be lacking certain information, for example, a name of a qualifying entity for tax reclaim and therefore requires support evidence in the form of secondary evidence.

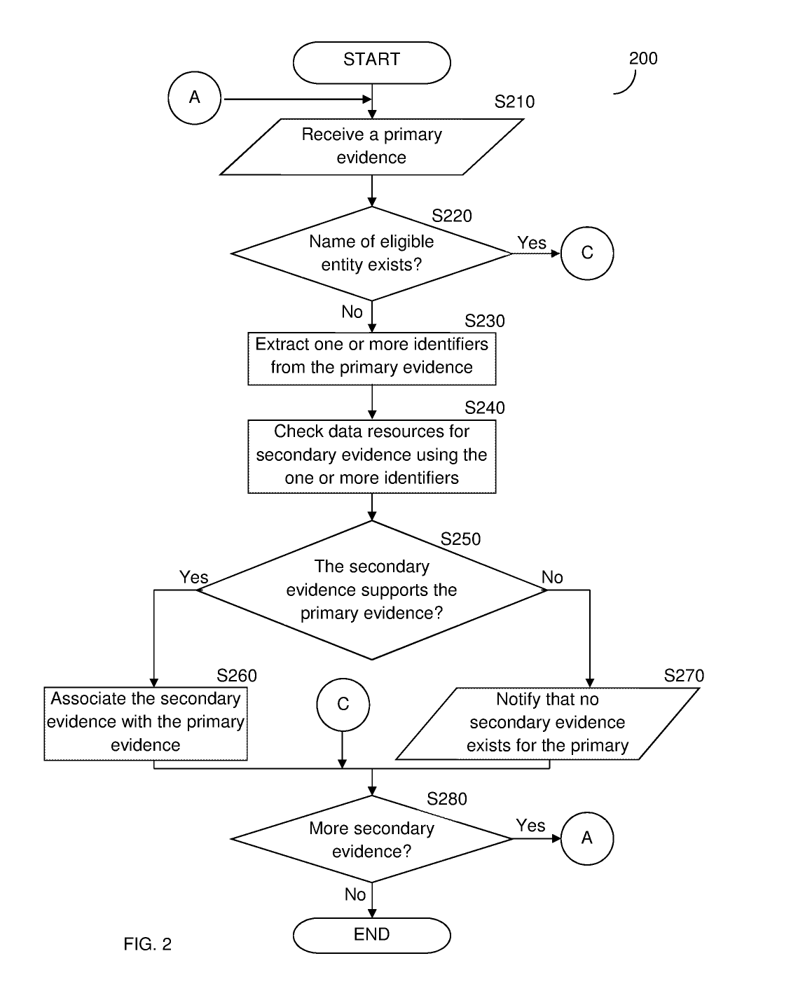

FIG. 2 is an example flowchart 200 for associating secondary evidence to primary evidence for the purpose of analyzing electronic documents according to an embodiment. At S210, an electronic document as primary evidence is received from a data repository. The received document may be a scanned image of the electronic document.

At S220, it is checked if the primary evidence contains a required information, such as a name of a qualifying entity. If the primary evidence lacks the required information, execution continues with S230; otherwise execution continues with S280. It should be noted that the qualifying entity is based on the analysis to be performed.

It should be further noted that in S220 a more general check is also possible without departing from the scope of the invention, which includes checking whether any required information for tax reclaim eligibility is present. If such information is present, execution continues with S280 and if it is not, execution continues with S230. In yet another embodiment, while the information for tax reclaim eligibility may suffice from a tax authority perspective, an entity may apply more severe regulations and therefore require that under certain conditions secondary evidence should be detected even if from a purely regulatory perspective these are not necessarily required. For example, expenditure during a weekend may be eligible for tax reclaim according to regulations but not according to an entities policy. The name of a qualifying entity may be a single one in the case of a company where only one entity exists that is entitled for making tax reclaims. In yet a further embodiment, the required information may be based specifically on the policy of an entity, in exclusion of, or in addition to, a tax authority policy.

However, in other cases there may be multiple such entities and therefore all of these need to be checked and verified. Such information may be embedded as part of the report generator 120, or part of a database, for example any database of data resource 150 or another database or source of data which are not shown. Such databases may further contain rules for association of a particular tax receipt to an eligible entity, and in some cases it may be possible that more than one such entity has such entitlement and such a case should be considered within the scope of the instant disclosure.

At S230, one or more distinguishing identifiers are extracted from the primary evidence. These may include, but are not limited to, dates, name of a person or entity, address, type of service, amounts paid, and the like. At S240, using the one or more distinguishing identifiers, the data resource 150 are checked for existence of secondary evidence in the form of, but not limited to, e-mails, data files, text files, presentations, trip reports, trip authorization documents, eligible proof of payment and the like, that may have an association between the primary evidence and the potential secondary evidence. A set of rules stored, for example but not by way of limitations, in a memory, may be used to identify potential secondary evidence.

At S250, it is checked whether documents were found that may be used as secondary evidence and if so, execution continues with S260; otherwise, execution continues with S270. At S260, as a determination was made that there is one or more primary evidences that may be associated with the primary evidence, such an association is made, for example, but not by way of limitation, by providing a pointer from the primary evidence to the one or more secondary evidences such that when it is necessary to retrieve secondary evidence for the primary evidence, the retrieval can be easily performed. In one embodiment such secondary evidence is provided, for example but not by way of limitation, to a requestor of such secondary evidence.

At S270, a notification may be sent to a requestor of such secondary evidence that no such secondary evidence has been found. At S280 it is checked whether more primary evidences are to be checked and if so execution continues with S210; otherwise, execution terminates.

In an exemplary and non-limiting embodiment the process described with respect of S240 may be performed using machine learning capabilities of the report generator 120. However, for such a machine learning process to be operative a learning process must take place. Such a learning process may involve the generation of a model that is based on past association of primary and secondary evidence, which may or may not have been validated as permissible by tax reclaim authorities. By validation, it is meant that an accredited authority has accepted the association of the primary evidence and the secondary evidence as permissible for the sake of receiving a reclaim under the rules. It should be further noted that the rules themselves may be part of the learning of the machine so that finer and more accurate results may be achieved. Moreover, the learning process may be repeated periodically, either manually or automatically, and then tested on a training set to ensure that the learning model provides accurate enough results.

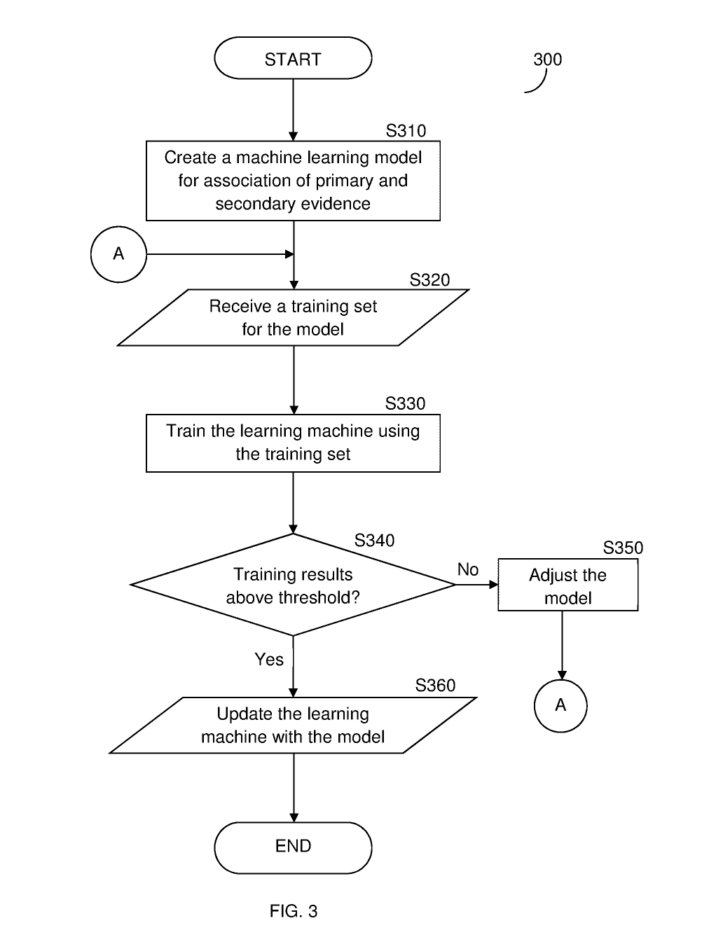

FIG. 3 describes an exemplary and non-limiting flowchart 300 for the training of a learning machine for validating a model of association of secondary evidence to primary evidence for the purpose of a VAT reclaim according to an embodiment. At S310, a learning model based on machine learning of previously collected data that successfully associated primary evidence with corresponding secondary evidence is generated. At S320, a training set for the generated model is received. At S330, the training set is tested on the machine learning model.

At S340, it is checked whether the results of the training set is above a predetermined threshold, the threshold determining a level of acceptance of adherence between the expected results and the results achieved by the model being trained. If the results correspond as expected or better, execution continues with S360; otherwise, execution continues with S350.

At S350, a model generated is automatically or manually adjusted and execution continues with S320. At S350, a computing unit 120 executing the machine learning is updated with the new model of machine learning and thereafter execution terminates. Accordingly, a machine learning model is generated that is based on past experience, trained, and adjusted such that when real data is processed through the system 100, primary evidence is properly associated with secondary evidence. One of ordinary skill in the art would readily appreciate that performing such tasks manually is not only error prone but also a slow and daunting task, especially when large numbers of primary evidence need to find a match with appropriate and admissible secondary evidence.

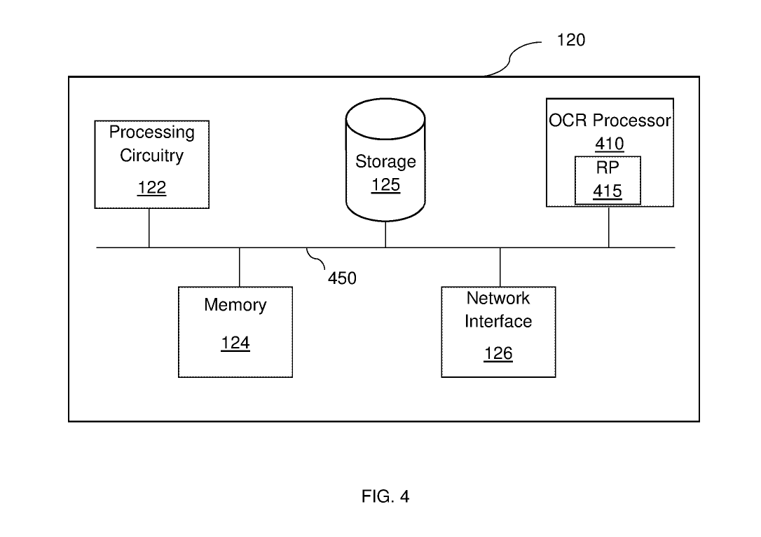

FIG. 4 is an example schematic diagram of the report generator 120 according to an embodiment. The report generator 120 includes a processing circuitry 122 coupled to a memory 124, a storage 125, and a network interface 126. In an embodiment, the report generator 120 may include an optical character recognition (OCR) processor 410. In another embodiment, the components of the report generator 120 may be communicatively connected via a bus 450.

The processing circuitry 122 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 124 may be volatile (e.g., RAM, etc.), non-volatile (e.g., ROM, flash memory, etc.), or a combination thereof. In one configuration, computer readable instructions to implement one or more embodiments disclosed herein may be stored in the storage 125.

In another embodiment, the memory 124 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 122 to perform the various processes described herein. Specifically, the instructions, when executed, cause the processing circuitry 122 to generate reports based on electronic documents, as discussed herein.

The storage 125 may be magnetic storage, optical storage, and the like, and may be realized, for example, as flash memory or other memory technology, CD-ROM, Digital Versatile Disks (DVDs), or any other medium which can be used to store the desired information.

The OCR processor 410 may include, but is not limited to, a feature and/or pattern recognition processor (RP) 415 configured to identify patterns, features, or both, in unstructured data sets. Specifically, in an embodiment, the OCR processor 410 is configured to identify at least characters in the unstructured data. The identified characters may be utilized to create a dataset including data required for verification of a request.

The network interface 126 allows the report generator 120 to communicate with the network 110, the repository 140, the scanner 130, the web sources 150, or a combination thereof, of FIG. 1 for the purpose of, for example, collecting metadata, retrieving data, storing data, and the like.

It should be understood that the embodiments described herein are not limited to the specific architecture illustrated in FIG. 4, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for associating of a primary evidence with at least one secondary evidence, comprising:
determining if a primary evidence contains a required information;
extracting at least one distinguishing identifier from the primary evidence upon determination that the primary evidence lacks the required information;
searching a data source for at least one secondary evidence that has an association with the primary evidence based on the at least one distinguishing identifier; and,
determining whether the at least one secondary evidence qualifies as an eligible secondary evidence and associating the at least one secondary evidence with the primary evidence when it is determined that the at least one secondary evidence is an eligible secondary evidence.

2. The method of claim 1, wherein the lack of required information is lack of explicit identification of an entity eligible for a tax reclaim.

3. The method of claim 1, wherein the determining and the associating is performed by machine learning.

4. The method of claim 3, wherein the machine learning is trained on data including previously associated primary evidence to secondary evidence.

5. The method of claim 4, wherein the previously associated primary evidence to secondary evidence is an association confirmed as eligible by a tax authority.

6. The method of claim 1, wherein the primary evidence is a tax receipt.

7. The method of claim 6, wherein the tax receipt is a value added tax receipt.

8. The method of claim 1, wherein the secondary evidence is at least one of: an e-mail, a trip report, a presentation, a data file, a trip authorization document, and an eligible proof of payment.

9. The method of claim 1, wherein the required information is based on at least a tax regulation.

10. The method of claim 9 wherein the required information is further based on a policy of an entity eligible for a tax reclaim.

11. A non-transitory computer readable medium having stored thereon instructions for causing a processing circuitry to perform a process, the process comprising:
determining if a primary evidence contains a required information;
extracting at least one distinguishing identifier from the primary evidence upon determination that the primary evidence lacks the required information;
searching a data source for at least one secondary evidence that has an association with the primary evidence based on the at least one distinguishing identifier; and,
determining whether the at least one secondary evidence qualifies as an eligible secondary evidence and associating the at least one secondary evidence with the primary evidence when it is determined that the at least one secondary evidence is an eligible secondary evidence.

12. A report generator for associating of a primary evidence with at least one secondary evidence, comprising:
a processing circuitry; and
a memory, the memory containing instructions that, when executed by the processing circuitry, configure the system to:
determine if a primary evidence contains a required information;
extract at least one distinguishing identifier from the primary evidence upon determination that the primary evidence lacks the required information;
search a data source for at least one secondary evidence that has an association with the primary evidence based on the at least one distinguishing identifier; and,
determine whether the at least one secondary evidence qualifies as an eligible secondary evidence and associate the at least one secondary evidence with the primary evidence when it is determined that the at least one secondary evidence is an eligible secondary evidence.

13. The report generator of claim 12, wherein the lack of required information is lack of explicit identification of an entity eligible for a tax reclaim.

14. The report generator of claim 12, wherein the determining and the associating is performed by machine learning.

15. The report generator of claim 14, wherein the machine learning is trained on data including previously associated primary evidence to secondary evidence.

16. The report generator of claim 15, wherein the previously associated primary evidence to secondary evidence is an association confirmed as eligible by a tax authority.

17. The report generator of claim 12, wherein the primary evidence is a tax receipt.

18. The report generator of claim 17, wherein the tax receipt is a value added tax receipt.

19. The report generator of claim 12, wherein the secondary evidence is at least one of: an e-mail, a trip report, a presentation, a data file, a trip authorization document, and an eligible proof of payment.

20. The report generator of claim 12, wherein the required information is based on at least a tax regulation.

21. The report generator of claim 20 wherein the required information is further based on a policy of an entity eligible for a tax reclaim.
